(19) United States
(12) Patent Application Publication
(10) Pub. No.: US 2025/0090958 A1
(43) Pub. Date: Mar. 20, 2025

(54) APPARATUS AND METHOD FOR VIDEO GAMES

(71) Applicant: Sony Interactive Entertainment Inc., Tokyo (JP)

(72) Inventors: Patrick John Connor, London (GB); Laura Elek, London (GB); Ian Plater, London (GB); Daniel Alan Spong, London (GB)

(73) Assignee: Sony Interactive Entertainment Inc., Tokyo (JP)

(21) Appl. No.: 18/884,341

(22) Filed: Sep. 13, 2024

(30) Foreign Application Priority Data
Sep. 18, 2023 (GB) 2314202.9

(51) Int. Cl. A63F 13/67; A63F 13/533; A63F 13/5375; A63F 13/56; A63F 13/79

(52) U.S. Cl. CPC A63F 13/67; A63F 13/79; A63F 13/533; A63F 13/5375; A63F 13/56

(57) ABSTRACT

An apparatus comprises receiving circuitry to receive user information indicative of an inactivity period for one or more video games previously played by a user, prediction circuitry to predict a mitigation action associated with a respective video game of the one or more video games previously played by the user in dependence on at least an inactivity period for the respective video game and generate video game mitigation information for the mitigation action associated with the respective video game, the prediction circuitry comprising one or more trained machine learning models to predict the mitigation action in dependence on at least the inactivity period for the respective video game, and output circuitry to output the video game mitigation information.

### FIELD OF THE DISCLOSURE

The present disclosure relates to data processing. In particular, the present disclosure relates to data processing for improving usability of video games.

### DESCRIPTION OF THE PRIOR ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior against the present disclosure.

Video games exist for which one or more difficulty settings can be varied. Video games may provide users with an adjustable difficulty based on different selectable difficulty levels and/or varying parameters. For example, difficulty associated with a video game may be varied by controlling parameters associated with game play aspects such as speed and/or agility of characters (e.g. non-player characters and/or player characters), health of characters, aggressiveness of character and other similar aspects. Dynamic game difficulty balancing techniques exist for automatically balancing such parameters during gameplay by monitoring a user's gameplay during the gameplay for providing challenging gameplay.

It is an aim to improve usability of video games.

It is in the context of the above arrangements that the present disclosure arises.

Various aspects and features of the present disclosure are defined in the appended claims and within the text of the accompanying description. Example embodiments include at least a data processing apparatus, a method, a computer program and a machine-readable, non-transitory storage medium which stores such a computer program.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a computer game processing apparatus;

FIG. 2 is a schematic diagram illustrating a data processing apparatus; and

FIG. 3 is a schematic flowchart of a data processing method.

### DESCRIPTION OF THE EMBODIMENTS

In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

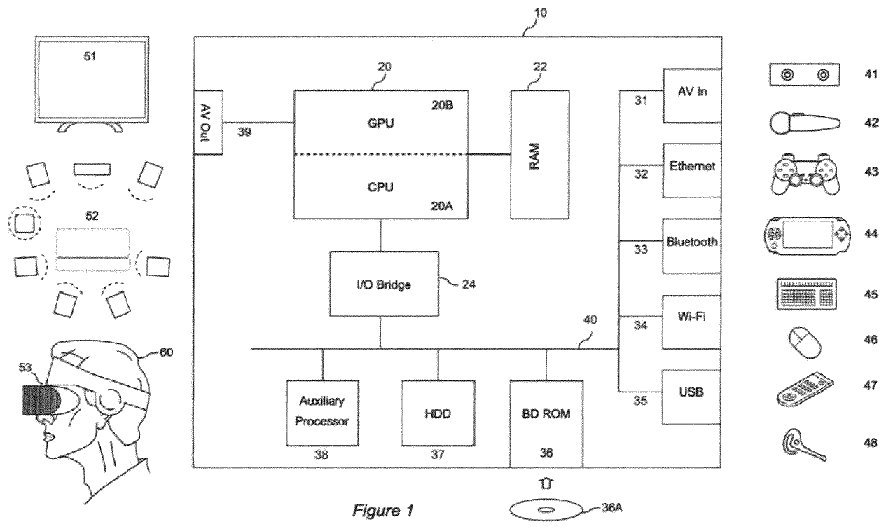

FIG. 1 schematically illustrates the overall system architecture of a computer game processing apparatus such as the Sony® PlayStation 4® entertainment device. A system unit 10 is provided, with various peripheral devices connectable to the system unit.

The system unit 10 comprises an accelerated processing unit (APU) 20 being a single chip that in turn comprises a central processing unit (CPU) 20A and a graphics processing unit (GPU) 20B. The APU 20 has access to a random access memory (RAM) unit 22.

The APU 20 communicates with a bus 40, optionally via an I/O bridge 24, which may be a discreet component or part of the APU 20.

Connected to the bus 40 are data storage components such as a hard disk drive 37, and a Blu-ray® drive 36 operable to access data on compatible optical discs 36A. Additionally the RAM unit 22 may communicate with the bus 40.

Optionally also connected to the bus 40 is an auxiliary processor 38. The auxiliary processor 38 may be provided to run or support the operating system.

The system unit 10 communicates with peripheral devices as appropriate via an audio/visual input port 31, an Ethernet® port 32, a Bluetooth® wireless link 33, a Wi-Fi® wireless link 34, or one or more universal serial bus (USB) ports 35. Audio and video may be output via an AV output 39, such as an HDMI port.

The peripheral devices may include a monoscopic or stereoscopic video camera 41 such as the PlayStation Eye®; wand-style videogame controllers 42 such as the PlayStation Move® and conventional handheld videogame controllers 43 such as the DualShock 4®; portable entertainment devices 44 such as the PlayStation Portable® and PlayStation Vita®; a keyboard 45 and/or a mouse 46; a media controller 47, for example in the form of a remote control; and a headset 48. Other peripheral devices may similarly be considered such as a printer, or a 3D printer (not shown).

The GPU 20B, optionally in conjunction with the CPU 20A, processes data and generates video images (image data) and optionally audio for output via the AV output 39. Optionally, the audio may be generated in conjunction with or instead by an audio processor (not shown).

The video and optionally the audio may be presented to a television 51. Where supported by the television, the video may be stereoscopic. The audio may be presented to a home cinema system 52 in one of a number of formats such as stereo, 5.1 surround sound or 7.1 surround sound. Video and audio may likewise be presented to a head mounted display unit 53 worn by a user 60.

In operation, the entertainment device defaults to an operating system such as a variant of FreeBSD 9.0. The operating system may run on the CPU 20A, the auxiliary processor 38, or a mixture of the two. The operating system provides the user with a graphical user interface such as the PlayStation Dynamic Menu. The menu allows the user to access operating system features and to select games and optionally other content.

FIG. 1 therefore provides an example of a data processing apparatus suitable for executing an application such as a video game.

The operations to be discussed below relate to techniques for improving usability of one or more video games. The inventors have identified that upon returning to play a given video game after a period of inactivity for that given video game (i.e. a period of time since the video game was last played), a user may have difficulty in playing the video game and that this can deter some users from revisiting previously played video games. For example, a user may potentially spend a significant amount of time playing a given video game and develop a familiarisation with the given video game, and upon returning to play the given video game the user's familiarity may have declined. The operations to be discussed below relate to improving usability of a video game by predicting a mitigation action for a given video game previously played by a user in dependence on at least an inactivity period for the given video game.

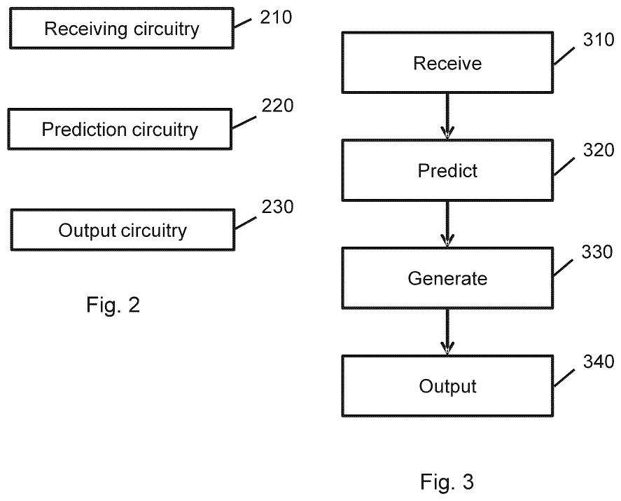

FIG. 2 schematically illustrates a data processing apparatus 200 for improving usability of a video game in accordance with embodiments of the disclosure. The data processing apparatus 200 comprises receiving circuitry 210, prediction circuitry 220, and output circuitry 230. The data processing apparatus 200 may for example be provided as part of a server device and/or as part of a user's entertainment device. In some examples, the data processing apparatus 200 may be provided as part of a user's device such as a smartphone, laptop or video game console such as that described with reference to FIG. 1.

The receiving circuitry 210 is configured to receive user information indicative of an inactivity period for one or more video games previously played by a user. User information for a respective user indicative of at least an inactivity period for a respective video game can be acquired by the apparatus 200. In some examples, an inactivity period for a first video game and another inactivity period for another video game may be acquired and the techniques to be discussed below regarding prediction of one or more mitigation actions for a respective video game may potentially be performed with respect to more than one video game in some cases. However, for the purposes of clarity of explanation the techniques will mainly be discussed with regards to a respective video game.

In the following discussion, an inactivity period for a respective video game refers to a period of time between a time at which the respective video game was last played by the user and a current time. In some examples, the inactivity period for a respective video game may be a period of time during which the user has also been inactive with respect to other video games, or the inactivity period for the respective video game may be a period of time during which the user has played one or more other video games different from the respective video game.

An inactivity period for a respective video game may have a duration of hours, days, weeks, months or even years. During the inactivity period for the respective video game, one or more other video games may or may have not been played. For example, a user may have decided to stop playing a respective video game in favour of playing one or more other video games. Alternatively, a user may have decided to stop playing video games all together and thus the inactivity period for the respective video game may be a period of total inactivity by the user (i.e. total inactivity with respect to playing of video games).

The receiving circuitry 210 is configured to receive user information for at least one user. The techniques of the present disclosure will generally be discussed in relation to user information for a respective user for predicting a mitigation action associated with a respective video game of one or more video games previously played by that user. However, more generally in some examples, the receiving circuitry 210 can receive user information for a plurality of users and the techniques discussed herein can be performed for a plurality of users so as to predict mitigation actions associated with a plurality of video games for improving usability of video games for a plurality of users.

The apparatus 200 may be a server apparatus that receives user data for a plurality of respective users via one or more networks (e.g. the internet) and predicts a mitigation action for a videogame that has been played by a given user and generates video game mitigation information for providing one or more mitigation actions associated with the video game. In other examples, the apparatus 200 may be provided a part of a video game console and user information generated by the video game console indicating activities of the user may be received by the receiving circuitry 210 for obtaining a prediction for one or more video games that have previously been played by the user.

In some examples, the received user information may comprise information associated with a user's account for a gaming platform and/or an online social network. For example, a user account (such as a PlayStation® Network account and/or other similar account for other gaming platforms and/or a social networking account) may store information associated with past activity by the user. In particular, activity information such as a time at which a video game has been played by the user may be stored as part of the user's account. The activity information may specify a time (one or more of a start time and an end time) at which a given video game was last played either as a relative time (e.g. N days ago) or as an absolute time (e.g. as a time and a date). Moreover, the user account may store activity information for characterising the user's game play such as which games have been played by the user and when the games have been played by the user, and optionally how long each of the games has been played by the user.

Hence more generally, the receiving circuitry 210 is configured to receive user information indicative of an inactivity period for at least one video game previously played by a user. In some cases, the user information may be indicative of historical activity by the user over a period of time such that the user information can be considered suitable for characterising the user's game play activities. The user information may be indicative of a last play time associated with each of a plurality of video games that have been previously played by the user which can be used for determining inactivity periods for the plurality of video games and various activities with respect to other games during an inactivity period for a given video game. The user information may be indicative of an inactivity period for a first respective video game and another inactivity period for another respective video game. Optionally, the received user information may be indicative of further information associated with at least the first respective video game (and/or the another respective video game) such as a duration of one or more previous game sessions and/or a previous difficulty associated with a given video game, as discussed in more detail later.

In some embodiments of the disclosure, the user information may specify an inactivity period with respect to a video game (e.g. as a relative and/or absolute time) and one or more from the list consisting of: i) a previous difficultly associated with a previous game session for that video game; ii) whether one or more other video games have been played by the user during the inactivity period with respect to the video game; iii) a duration of one or more previous game sessions for one or more other video games during the inactivity period with respect to the video game; iv) a genre of one or more other video games played during the inactivity period with respect to the video game; v) a duration of one or more previous game sessions by the user for the video game (e.g. a total duration); and vi) a ranking and/or skill level previously attained for the video game. In the techniques to be discussed below, the data processing apparatus 200 is operable to predict a mitigation action for a respective video game in dependence on at least an inactivity period for a respective video game, and other optional arrangements may additionally use one or more of the items i) to vi) listed above.

The prediction circuitry 220 is configured to predict a mitigation action associated with a respective video game of the one or more video games previously played by the user in dependence on at least an inactivity period for the respective video game and generate video game mitigation information for providing one or more mitigations associated with the respective video game, the prediction circuitry 220 comprising one or more trained machine learning models to predict the mitigation action in dependence on at least the inactivity period for the respective video game.

The received user information indicative of at least an inactivity period for the respective video game which has been previously played by the user is used by one or more machine learning models to predict a mitigation action for the respective video. At least the inactivity period for the respective video game (or a pre-processed representation thereof) can be provided as an input to at least one machine learning model that has been trained to predict a mitigation action associated with the respective video game in dependence on at least the inactivity period for the respective video game.

More generally, reduction in familiarity and/or ability of users for playing a video game (e.g. due to a reduction in familiarity, skill and or other aspects) associated with inactivity with respect to the video game can be modelled on the basis of the training data examples discussed later. Generally, it can be expected that longer periods of inactivity may be associated with a greater reduction in familiarity and/or ability compared to shorter periods of inactivity. Moreover, for some cases it may be that initially there is little or no reduction in ability, subsequently followed by a relatively sharp reduction, and then subsequently followed by a more gradual reduction converging towards a general baseline ability. Such time-based reduction in ability may differ from one video game to another, and/or from one video game series and/or video game genre to another.

In the techniques of the present disclosure, the prediction circuitry 220 comprises one or more machine learning models trained to provide an output for predicting a mitigation action depending on a period of inactivity. This can assist in appropriately mitigating according to the user's period of inactivity and the associated reduction in familiarity and/or ability of the user.

In response to predicting the mitigation action, the prediction circuitry is operable to generate the video game mitigation information for the mitigation action associated with the respective video game. The video game mitigation information may comprise one or more from the list consisting of: video game difficulty setting information for reducing difficulty associated with a respective video game; a notification indicative of a controller mapping associated with the respective video game; a tutorial associated with the respective video game; and an auto-complete function associated with the respective video game. Hence, in the present disclosure one or more mitigation actions may be performed with respect to the respective video game so as to improve usability of that video game for the user following a period of inactivity with respect to that video game. Whilst mitigation may be achieved by reducing difficulty associated with the respective video game so that a next game session can be played with a reduced difficulty, one or more of the other above mentioned mitigation actions may be performed (instead or in addition) to assist in reducing difficulty perceived by the user.

One or more notifications may be provided to remind a user of a controller mapping (e.g. a last used controller mapping) for the video game. For example, the notification may comprise one or more of text and/or images for indicating to the user a mapping between inputs of a controller and in-game functions for the video game. Alternatively or in addition, one or more tutorials may be provided to re-introduce the user to one or more aspects of the video game before starting a session for the video game. For example, a tutorial may provide a refresher with respect to one or more movements and/or functions to be performed within the video game. In some examples, a tutorial with a duration in the range of 30 seconds to 5 minutes may be provided. The tutorial may comprise a mini-game comprising an objective to be completed. Alternatively or in addition, one or more auto-complete functions associated with the respective video game may be provided. An auto-complete function for allowing automatic completion of input sequences by the user may be provided. In some examples, an auto-complete function may be provided for a limited period of time at the start of the subsequent game session for providing initial assistance during that portion of the session.

More generally, the prediction circuitry 220 comprises one or more machine learning models trained to provide an output for predicting a mitigation action depending on a period of inactivity. In response to prediction of a mitigation action, the prediction circuitry 220 is configured to generate video game mitigation information which may provide any of the mitigation actions discussed previously. The following discussion will generally refer to predicting a mitigation action associated with a respective video game and generating video game mitigation information for reducing a difficulty associated with the respective video game. However, it will be appreciated that in the following discussion reduction of the difficulty associated with the respective video game may be supplemented with one or more of the other possible mitigation actions or may be substituted with one of more of the other possible mitigation actions.

Hence, in embodiments of the disclosure, the data processing apparatus 200 comprises: the receiving circuitry 210 configured to receive user information indicative of an inactivity period for one or more video games previously played by a user; the prediction circuitry 220 configured to predict a mitigation action associated with a respective video game of the one or more video games previously played by the user in dependence on at least an inactivity period for the respective video game and generate video game mitigation information for the mitigation action associated with the respective video game, the prediction circuitry 220 comprising one or more trained machine learning models to predict the mitigation action in dependence on at least the inactivity period for the respective video game; and the output circuitry 230 configured to output the video game mitigation information.

In some embodiments of the disclosure, the mitigation action comprises a reduction in difficulty associated with the respective video game. Hence, in some embodiments of the disclosure, data processing apparatus 200 comprises: the receiving circuitry 210 configured to receive user information indicative of an inactivity period for one or more video games previously played by a user; the prediction circuitry 220 configured to predict a reduction in difficulty (e.g., whether to reduce and/or an amount by which to reduce) associated with a respective video game of the one or more video games previously played by the user in dependence on at least an inactivity period for the respective video game and generate video game difficulty setting information for reducing difficulty associated with the respective video game, the prediction circuitry 220 comprising one or more trained machine learning models to predict the reduction in difficulty in dependence on at least the inactivity period for the respective video game; and the output circuitry 230 configured to output the video game difficulty setting information.

In the following discussion, references to predicting a mitigation action associated with the respective video game may be replaced like for like with references to predicting a reduction in difficulty associated with the respective video game and/or predicting an amount of reduction in difficulty associated with the respective video game.

The prediction can be made by the prediction circuitry 220 at a time prior to starting a next game session for the video game. For example, the prediction may be obtained in response to a user selecting a video game to be played. Alternatively, the prediction may be obtained in response to a user logging into a user account associated with a gaming platform. For example, a user account associated with a gaming platform (such as the PlayStation® gaming platform and the PlayStation® Network account) may comprise information for various games that have been and may next be played by the user. A login operation associated with such a user account may in some cases trigger one or more predictions to be obtained with respect to one or more video games associated with the user account.

In some examples, a machine learning model may be trained to output data indicative of whether to perform a mitigation action associated with the respective video game depending on the inactivity period. Hence, in some cases the output of the machine learning model may be a binary output to indicate one of a prediction to perform mitigation and a prediction not to perform mitigation. In particular, in some cases the output of the machine learning model may be a binary output to indicate one of a prediction to reduce difficulty and a prediction not to reduce difficulty.

For example, the machine learning model may be trained to predict a class label from a first and second class label in dependence on an input comprising an inactivity period for a respective video game, in which the first class label and the second class label indicate performance of mitigation (e.g. reduction in difficulty) and no performance of mitigation (e.g. no reduction in difficulty), respectively. Such a machine learning model may be trained using various learning techniques. In some examples, supervised learning techniques may be used for which training data comprises an inactivity period and an associated label indicating whether a reduction in difficulty was used by a user for a next game session following the inactivity period. In this way, the machine learning model may be trained to learn to output one of the first class label and the second class label in response to an input comprising an inactivity period for a video game. Using such training data, a machine learning model can be trained to predict a mitigation action and optionally any one of the previously mentioned types of mitigation may be used.

In the above discussion, the training data may relate to inactivity periods for a number of respective users with respect to a same video game. For example, the machine learning model may be trained specifically with respect to a respective video game title. Alternatively, the machine learning model may be trained using training data that relates to inactivity periods for a number of respective users with respect to a plurality of video games from a same video game series (e.g. a video game series comprising a plurality of shooting video games, such as the Call of Duty® game series). For example, the machine learning model may be trained using training data for a video game series so that in response to receiving an input comprising an inactivity period for a respective video game of the video game series, the machine learning model can output one of the first and second class label for predicting a mitigation action (e.g. a reduction in difficulty) for the respective video game. Alternatively, the machine learning model may be trained using training data that relates to inactivity periods for a number of respective users with respect to a same video game genre. For example, a video game genre such as shooter games, action games, role playing games, sports simulation games, racing games and so on may be used. In this way, the machine learning model may be trained using training data for a video game genre so that in response to receiving an input comprising an inactivity period for a respective video game of the video game genre, the machine learning model can output one of the first and second class label for predicting a mitigation action (e.g. a reduction in difficulty) for the respective video game.

In some examples, the prediction circuitry 220 may comprise one or more of: a first machine learning model trained using training data associated with a respective video game; a second machine learning model trained using training data associated with a respective video game series; and a third machine learning model trained using training data associated with a respective video game genre.

The prediction circuitry 220 may comprise a plurality of machine learning models at least some of which have been trained for two or more different respective video games. In some examples, the prediction circuitry 220 may comprise a plurality of machine learning models at least some of which have been trained for two or more different respective video game series. In some examples, the prediction circuitry 220 may comprise a plurality of machine learning models at least some of which have been trained for two or more different video game genres.

For example, one machine learning model may have been trained using training data associated with a plurality of video games each corresponding to a first video game genre (e.g. shooter games) and another machine learning model may have been trained using training data associated with another plurality of video games each corresponding to a second video game genre (e.g. racing games).

More generally, in some examples the prediction circuitry 220 may comprise any suitable number of machine learning models each trained using a different training data set for predicting a mitigation action. In some examples, the prediction circuitry 220 may comprise a single trained machine learning model trained for one of a respective video game, a respective video game series and a respective video game genre.

In some examples, one or more of the machine learning models may be trained using supervised learning techniques. Generally, labelled training data may be used for learning a function for mapping an input (e.g. provided as one or more feature vectors) to an output (e.g. a label associated with the training data). Examples of such techniques will be discussed in detail later. Example suitable learning algorithms may include linear regression, logistic regression, artificial neural networks, decision trees, support vector machines (SVM), random forests, and the K-nearest neighbour algorithm. In some cases, reinforcement learning techniques using an action and reward feedback loop using feedback from multiple users may be used.

In response to receiving user information indicative of an inactivity period for a video game previously played by the user, the prediction circuitry 220 can input the user information indicative of at least the inactivity period for the video game into at least one of a machine learning model trained for that video game (e.g. the above mentioned first machine learning model), another machine learning model trained for a video game series comprising that video game (e.g. the above mentioned second machine learning model), and another machine learning model trained for a video game genre corresponding to that video game (e.g. the above mentioned third machine learning model). For example, whilst it may be preferable to use a machine learning model that has been trained specifically for a given video game, in some cases a prediction may be required for a video game for which the prediction circuitry 220 may not comprise a specifically trained machine learning model. Hence, in such cases a machine learning model trained with respect to a same video game series and/or a machine learning model trained with respect to a same video game genre may be used.

Hence, in some embodiments of the disclosure the prediction circuitry 220 can be configured to detect one or more of a video game title, video game series title and genre associated with a video game for which a prediction is to be provided, select a machine learning model in dependence on the detection and input at least the inactivity period into the selected machine learning model. For example, whether a detected video game title matches a video game title for which a machine learning model has been trained may firstly be performed so that such a machine learning model can be used for the prediction when available. Whether a detected video game series title matches a video game series title for which a machine learning model has been trained may secondly be performed so that such a machine learning model can be used for the prediction when available. And, whether a detected video game genre matches a video game genre for which a machine learning model has been trained may thirdly be performed so that such a machine learning model can be used for the prediction when available. In the above discussion, it will be appreciated that in some examples the prediction circuitry 220 may not comprise any machine learning models trained for a video game series title, and the operation of whether a detected video game genre matches a video game genre for which a machine learning model has been trained may be performed as a second operation following the above mentioned first operation. In some examples, the received user information may comprise metadata for indicating one or more of a video game title, video game series title and genre associated with an inactivity period for a previously played video game.

The above techniques provide examples in which the prediction circuitry 220 comprises one or more machine learning models trained to provide an output for indicating whether to perform a mitigation action (or more specifically, whether to reduce difficulty) associated with a respective video game. In response to an output indicating to perform mitigation, the prediction circuitry 220 can be configured to generate the video game mitigation information to provide one or more of the mitigation actions discussed previously.

In some examples, a machine learning model may be trained to provide an output to indicate to reduce difficulty and the prediction circuitry 220 may be configured to generate the video game difficulty setting information for reducing difficulty associated with the respective video game by a given amount. For example, the prediction circuitry 220 may be programmed so that in response to such an output, the video game difficulty setting information is generated to specify a relative reduction in difficulty by a given amount (e.g. reduction by a given percentage such as a value in the range 5% to 20%). The video game difficulty setting information can thus be generated and output by the output circuitry 230 for use by a video game processing device to reduce difficulty of a video game. In other cases to be discussed below, a trained machine learning model may output data indicative of a relative reduction in difficulty and/or may output data indicative of a difficulty setting to be used for a given video game.

Therefore, for a respective video game which the prediction circuitry 220 predicts reduction in difficulty in dependence on the inactivity period for the respective video game, the output circuitry 230 can output the video game difficulty setting information for reducing difficulty associated with the respective video game. The video game difficulty setting information may specify reduction in difficulty by a given amount relative to a current difficulty setting associated (e.g. reduction by 5%). Therefore, for a next session of the video game, the difficulty can be reduced relative to the current difficulty setting (which is expected to be unchanged from the last time the video game was played by the user) thereby improving usability of the video game for the next session.

In some examples, the prediction circuitry 220 may comprise one or more machine learning models trained to provide an output for indicating an amount of reduction in difficulty associated with a respective video game. For example, the above mentioned supervised learning techniques may be similarly performed using training data comprising a plurality of class labels for which two or more respective class labels indicate reduction in difficulty by a different amount. The training data may comprise inactivity periods and corresponding class labels indicating a relative amount of reduction in difficulty that was used for a next game session following the inactivity period. A first class label may indicate no reduction in difficulty, a second class label may indicate a reduction in difficulty within a first range and a third class label may indicate a reduction in difficulty within a second range. In this way, a machine learning model may be trained to learn to output one of the plurality of class labels in response to an input comprising an inactivity period for a video game for indicating an amount of reduction in difficulty.

For example, different class labels output by a machine learning model may be associated with different levels of reduction in difficulty. In response to a given class label (e.g. the first class label), the prediction circuitry 220 may generate the video game difficulty setting information for reducing difficulty associated with the respective video game by a first amount, and in response to another class label (e.g. the second class label), the prediction circuitry 220 may generate the video game difficulty setting information for reducing difficulty associated with the respective video game by a second amount.

Alternatively, at least one trained machine learning model may output a class label which itself comprises an indication of at least one of a relative amount of reduction for the difficulty and/or a difficulty setting for a given video game (e.g. reduce difficulty by X % and/or a value of a parameter for a difficulty setting to be used in a video game). Hence, in some embodiments of the disclosure, a machine learning model may receive an input comprising at least an inactivity period for a respective video game and output the video game difficulty setting information comprising at least one of relative reduction in difficulty associated with the respective video game and/or a difficulty setting to be used for the respective video game.

The above techniques represent a possible example for training one or more machine learning models to predict a reduction in difficulty associated with a respective video game. Other suitable training techniques may be used. As explained in more detail later, in some examples the training data may optionally comprise additional information to what has been discussed above.

In some embodiments of the disclosure, the user information is also indicative of a previous difficulty associated with a previous game session played by the user for the respective video game. In addition to indicating an inactivity period for a video game, the user information may also indicate a previous difficulty associated with a previous game session played by the user for that video game. Therefore, a most recently used difficulty for a most recent game session by the user immediately preceding the inactivity period may be received and used by the prediction circuitry 220 for the prediction. For example, the user information may indicate a difficulty setting such as easy, medium, hard, extreme or other similar identifiers (e.g. numerical ratings and/or one or more numerical values associated with one or more parameters associated with a difficulty for the video game).

The inventors have appreciated that reduction in familiarity and/or ability of users to play a video game may be dependent on inactivity with respect to the video game and also dependent on a previous attainment by the user with respect to the video game (e.g. ability to play at a given difficulty setting).

Differences in previous ability at a start of a period of inactivity may result in differences in time-based reduction in ability. For example, users with relatively low previous ability may be associated with little or no reduction in ability for some period of time which may then be followed by a gradual reduction converging towards a general baseline ability. Users with a relatively high previous ability may be associated with little or no reduction in ability for some period of time (which may be different from that for the users with lower previous ability) which may then be followed by a sharp reduction and then followed by converging to a baseline ability that may in some cases be higher than (or the same as) the general baseline ability. More generally, time-based reduction in ability may differ depending on an initial ability attained by a user and this may also differ from one video game to another, and/or from one video game series and/or genre to another.

Hence, in some embodiments of the disclosure the prediction circuitry 220 is configured to predict a mitigation action (or more specifically, predict a reduction in difficulty e.g. whether to reduce and/or an amount by which to reduce) associated with a respective video game in dependence on an inactivity period for the respective video game and a previous difficulty associated with a previous game session played by the user for the respective video game. One or more machine learning models can be trained so as to provide an output for predicting a mitigation action depending on a period of inactivity and a previous difficulty associated with a previous game session played by the user. This can potentially assist in appropriately reducing difficulty for a video game according to the user's period of inactivity, previous difficulty and the associated reduction in ability of the user.

Therefore, in response to user information indicative of an inactivity period for a respective video game and a previous difficulty associated with a previous game session played by the user for the respective video game, one or more of the machine learning models may be trained to provide an output for indicating whether to perform a mitigation associated with the respective video game and/or one or more of the machine learning models may be trained to provide an output for indicating an amount of reduction in difficulty associated with the respective video game.

All of the previously discussed machine learning training techniques may be similarly applied. Similar to the techniques discussed above, supervised learning techniques may be used to train one or more machine learning models which may be trained specifically for a respective video game, a video game series and/or a video game genre.

The training data may comprise inactivity periods for a plurality of users with respect to a same video game (or game series or genre). The training data with respect to each user may comprise an inactivity period, a label indicating whether a reduction in difficulty was used for a next game session following the inactivity period (as discussed previously) and also another label indicating a previous difficulty associated with a previous game session for the respective video game. The training data may be obtained for a number of respective users with respect to a same video game, a same video game series and/or a same video game genre. Such training data may be used to train a machine learning model to provide an output for indicating one or more of: whether to perform a mitigation; whether to reduce difficulty associated with a video game; and an amount by which to reduce difficulty.

For example, for user data for a given user indicative of a relatively long inactivity period and a relatively high difficulty for a previous game session and user data for another user indicative of a relatively short inactivity period and a relatively low difficulty for a previous game session, a trained machine learning model may predict to reduce difficulty for the video game for the given user and predict not to reduce difficulty for the video game for the another user. It will be appreciated that this may vary for different video games, different video game series and/or different video game genres. For example, ability with respect to a given shooter game may reduce differently (e.g. more quickly) compared to that for say a driving video game, or vice versa. Such properties can be learned during training on the basis of the training data as discussed above.

Alternatively or in addition, the training data may comprise an inactivity period, a label indicating a previous difficulty associated with a previous game session for the respective video game and another label indicating a relative difference (reduction) between the previous difficulty and a next difficulty used for a next game session following the inactivity period. Alternatively or in addition, the another label may indicate the next difficulty used for the next game session following the inactivity period, and a difference between the next difficulty and the previous difficultly obtained on this basis for training purposes. The training data may similarly be obtained for a number of respective users with respect to a same video game, a same video game series and/or a same video game genre. Such training data may be used to train a machine learning model to provide an output for indicating a relative amount of reduction in difficulty associated with a respective video game, in response to an input comprising an inactivity period for the video game and a previous difficulty associated with a previous game session for the respective video game. For example, in response to user data for a given user indicative of a relatively long inactivity period and a relatively high difficulty for a previous game session (i.e. a most recent game session by the given user that precedes the inactivity period), a trained machine learning model may predict to reduce difficulty for the video game for the given user by a first amount. For another user having a different inactivity period and/or different previous difficulty then a reduction in difficulty by a second amount different from the first amount may instead be predicted.

In some embodiments of the disclosure, the training data may be grouped according to a previous difficulty so as to obtain a plurality of training data groups for which a previous difficulty differs between each training data group. In this way, a machine learning model may be trained using a first training data group to learn a function for mapping an input comprising an inactivity period to an output comprising an indication of whether to reduce difficulty and/or an indication of an amount of reduction in difficulty. Similarly, the machine learning model (or another machine learning model) may be trained using a second training data group to learn another function for mapping an input comprising an inactivity period to an output comprising an indication of whether to reduce difficulty and/or an indication of an amount of reduction in difficulty. Hence, a first function can be learned for predicting reduction in difficulty for users associated with a first previous difficulty and another function can be learned for predicting reduction in difficulty for other users associated with a second previous difficulty different from the first previous difficulty. For example, a first function may be learned for relatively high skilled users (associated with a high previous difficulty) and a second function may be learn for relatively low skilled users (associated with a low previous difficulty).

Hence more generally, in some embodiments of the disclosure the prediction circuitry 220 comprises one or more machine learning models trained to learn a plurality of functions for mapping an input comprising an inactivity period to an output comprising an indication of whether to perform mitigation and/or whether to reduce difficulty and/or an indication of an amount of reduction in difficulty, in which each of the plurality of functions is associated with a different previous difficulty (or range in previous difficulty) for a game session prior to the inactivity period. In response to user data indicative of an inactivity period and a previous difficulty used by a user, an appropriate function can be selected from the plurality of functions and the inactivity period mapped by the selected function to an output for thereby predicting reduction in difficulty appropriately for the inactivity period and the previous difficulty. The above discussion refers to grouping the training data according to a previous difficulty and in some cases the different groups may correspond to different non-overlapping ranges of previous difficulty. For example, one function may be learned for a hard difficulty setting and another function may be learned for an easy difficulty setting. More generally, a plurality of functions may be learned for different levels of difficulty.

The above techniques provide examples in which the prediction circuitry 220 comprises one or more machine learning models trained to predict a reduction in difficulty associated with a respective video game in dependence on an inactivity period for the respective video game and a previous difficulty associated with a previous game session. In some embodiments of the disclosure, whether there has been activity (and/or an amount of such activity) by the user within the inactivity period for the respective video game may also be used for obtaining the prediction. Whether there has been activity (and/or an amount of such activity) within the inactivity period for the respective video game may be used in combination with the inactivity period and optionally the above mentioned previous difficulty may also be used for obtaining the prediction. For clarity of explanation the following techniques will omit discussion regarding use of a previous difficulty.

In some embodiments of the disclosure, the prediction circuitry 220 is configured to a mitigation action associated with a respective video game in dependence on an inactivity period for the respective video game and whether one or more other video games have been played by the user during the inactivity period for the respective video game.

The inventors have appreciated that reduction in familiarity and/or ability of users for a given video game may be dependent on an inactivity period with respect to the given video game and also whether a user has been playing one or more other video games whilst being inactive with respect to the given video game. It can be expected that longer periods of inactivity with respect to the given video game may be associated with a greater reduction in ability. However time-based reduction in ability for the given video game may differ depending on whether the user has been playing other video games during the period of inactivity for the given video game.

For example, some users may not play a given video game for a period such as one month. Within that month, users that do not play any other video games may be expected to have a sharper drop in familiarity and/or ability with respect to the given video game compared to other users that continue to play one or more other video games. It will be appreciated that the above mentioned machine learning techniques may be similarly implemented using the above mentioned training data for users and which further comprises an indication of whether one or more other video games have been played during the inactivity period. For example, the above mentioned technique of grouping training data may be used to group training data into two groups for which one group comprises training data for which the users did not play other video games in the inactivity period and another group comprises training data for which the users did play one or more other video games in the inactivity period. Respective functions may be learned using the respective groups of training data in a manner similar to that discussed previously.

In some embodiments of the disclosure, the prediction circuitry 220 is configured to predict a mitigation action associated with the respective video game in dependence on a duration of one or more previous game sessions for one or more of the video games other than the respective video game during the inactivity period for the respective video game. As well as considering whether one or more other video games have been played during the inactivity period for the respective video game, in the techniques of the present disclosure a duration of one or more previous game sessions during the inactivity period can be used for obtaining the prediction. Time-based reduction in ability for the respective video game may differ depending on an amount of gameplay by the user for one or more other video games within the inactivity period for the respective video game. For example, within the inactivity period, some users that have a relatively high play duration for one or more other video games may be expected to have a reduced drop in familiarity and/or ability with respect to the given video game than other users that have a relatively low play duration. The above mentioned machine learning techniques may be similarly implemented using the above mentioned training data for users which further comprises an indication of a duration of one or more other video games have been played during the inactivity period.

In some embodiments of the disclosure, the prediction circuitry 220 is configured to predict a mitigation action associated with the respective video game in dependence on a genre of one or more of the video games previously played by the user during the inactivity period for the respective video game. Time-based reduction in ability for the respective video game may differ depending on a genre of one or more other video games played by the user within the inactivity period for the respective video game. For example, some users that have played one or more other video games of a same genre as that of the respective video game may be expected to have a reduced drop in familiarity and/or ability with respect to the respective video game compared to other users that have played one or more other video games which are not of a same genre as the respective video game.

An example of this may be a case in which the respective video game is a shooter video game. For users that have played other shooter video games within the inactivity period for the respective video game it can be expected that such users may have little (or even no) reduction in in familiarity and/or ability with respect to the respective video game, whereas users that have not played other shooter video games (e.g. only played driving simulation games) can be expected to have a greater reduction in in familiarity and/or ability with respect to the respective video game. For a video game such as a respective video game of the Call of Duty® video game series, it can be expected that a user that does not play the respective video game and instead plays another video game of the Call of Duty® video game series may be able to subsequently play the respective video game at a later time with little or no reduction in ability and therefore a previous difficulty setting may still be appropriate for use for the next game session. In contrast to this, it can be expected that a user that does not play the respective video game and instead plays another video game of a different genre, such as a driving simulation game or sports game, may experience a reduction in in familiarity and/or ability with respect to the respective video game and therefore can be assisted by a reduction in difficulty for a next game session. It will be appreciated that various video game genres may be considered including one or more of: action games, sports games, massively multiplayer online role-playing game (MMORPG), adventure games, fighting games, driving games, shooter games and so on.

Hence more generally, the prediction circuitry 220 can be configured to predict a mitigation action associated with the respective video game in dependence on an inactivity period for the respective video game and whether a genre of one or more of the video games previously played by the user during the inactivity period for the respective video game corresponds to a genre associated with the respective video game.

Any of the above mentioned machine learning techniques may be similarly implemented using the above mentioned training data for a number of users and which may further comprise an indication of a genre of one or more other video games played during the inactivity period and/or whether one or more other video games of a same genre as the respective video game have been played during the inactivity period.

In some embodiments of the disclosure, the prediction circuitry 220 is configured to predict a mitigation action associated with the respective video game in dependence on a total duration of one or more previous game sessions for the respective video game within a predetermined period of time. Time-based reduction in familiarity and/or ability for the respective video game may differ depending on a duration for which the user has previously played the respective video game. Users that have spent a greater amount of time playing the respective video game can be expected to have a slower and more gradual reduction in familiarity and/or ability for the respective video game relative to other users that have spent a smaller amount of time playing the respective video game. For example, so-called muscle memory and more generally familiarisation, can be expected to fade differently for users that have accumulated days, weeks or even months of gameplay time for a video game compared to users that may have only accumulated hours or a few days of game play time.

Therefore, a total duration of one or more previous game sessions for the respective video game by the user associated with the received user data within a predetermined period of time may be used in addition to the inactivity period for the respective video game for predicting a mitigation action (or more specifically a reduction in difficulty) for the respective video game. The predetermined period of time may be set to any suitable value so as to generally characterise how familiar the user may have become with the respective video game up to the start time of the inactivity period. For example, the predetermined period of time may have a duration of a week, a month, six months or a year from one of a current time and a start time of the inactivity period, so as to characterise how much the video game has been played by the user within that interval. More generally, the predetermined period of time may have a duration in the range from one week to one year. Therefore, a duration of each game session by the user for the respective video game within the predetermined period of time can be summed to obtain the total duration of gameplay by the user for the respective video game within the predetermined period.

Any of the above mentioned machine learning techniques may be similarly implemented using the above mentioned training data for a number of users and which may further comprises an indication of a duration of one or more previous game sessions for the respective video game within a predetermined period of time.

In some embodiments of the disclosure, the prediction circuitry 220 is configured to generate the video game difficulty setting information to include one or more parameters specifying at least one of a relative reduction in difficulty associated with the respective video game and a difficulty setting to be used for the respective video game. In some embodiments of the disclosure, the output circuitry 230 is configured to output the video game difficulty setting information for use by a video game processing device for execution of a next session of the respective video game according to a difficulty that is dependent on the video game difficulty setting information. As explained previously, in some cases the apparatus 200 may be a user device such as a video game console device. Hence in some examples, the output circuitry 230 may output the video game difficulty setting information to a processor provided as part of the apparatus 200 for processing a video game. Alternatively, the apparatus 200 may output the video game difficulty setting information via one or more of a wired and a wireless communication or use by another device. For example, the apparatus 200 may be a server apparatus that generates the video game difficulty setting information and outputs the information by one or more other devices (e.g. game consoles and/or servers) that execute sessions for a video game. The subsequent session for the respective video game may thus be executed locally by the user's video game console using the video game difficulty setting information or in some cases may be a cloud-based video game session executed by one or more cloud servers.

Hence more generally some embodiments of the disclosure may provide a user device (e.g. video game console) comprising the receiving circuitry 210, the prediction circuitry 220, the output circuitry 230 and execution circuitry (e.g. CPU 20A and/or GPU 20B) operable to execute a next session for the respective video game in dependence on the video game difficulty setting information.

In some embodiments of the disclosure, the prediction circuitry 220 is configured to associate control information with the video game difficulty setting information for modifying the difficulty during the next session of the respective video game to increase the difficulty in response to one or more of a predetermined input by the user and an elapse of a predetermined period of time during the next session. Control information can be associated with the video game difficulty setting information for use by a video game processing device (e.g. game console and/or game server) during next game session for the respective video game. The video game difficulty setting information is used for the next game session to set a reduced difficulty (that is reduced comparative to a difficulty used the last time the user played the respective video game). The control information can be used during the next game session (potentially at any time) so as to modify the difficulty during the next session in a way that increases the difficulty.

The control information may specify a user input which when provided by the user during the next session causes an increase in difficulty (e.g. potentially a small increase relative to the current difficulty or an increase back to a difficulty that was used prior to the inactivity period). In some examples, the control information may specify a first user input which when provided by the user causes a first increase in the current difficulty by a first amount, and a second user input which when provided by the user causes a second increase in the current difficulty to a same difficulty that was used prior to the inactivity period. The first user input may cause an increase in the current difficulty by the first amount to a new difficulty that is between the current difficulty and the difficulty that was used prior to the inactivity period.

Alternatively or in addition, the control information may specify a predetermined period of time so that upon expiry of the predetermined period of time during the next session, the control information is used to automatically increase the difficulty for the respective video game. Hence, the control information may be used during the next session following the inactivity period to increase the difficulty to one of: a new difficulty between the current difficulty and the difficulty that was used prior to the inactivity period; and a new difficulty that is the same as a previous difficulty that was used prior to the inactivity period. For example, the predetermined period of time may have a duration in the range of 1-10 minutes. Other values may suitably be considered and different values may be more suitable for different types of video game.

In some embodiments of the disclosure, the control information may specify a first predetermined period of time and a second predetermined period of time. In response to expiry of the first predetermined period of time, the control information may be used to automatically increase the difficulty for the respective video game by a first amount. In response to expiry of the second predetermined period of time, the control information may be used to automatically increase the difficulty for the respective video game by a second amount. The first predetermined period of time can be set to expire prior to the second predetermined period of time. For example, the first predetermined period of time may expire at 1 minute after starting of the next game session, and the second predetermined period of time may expire at 2 minutes after starting of the next game session. Other suitable values may be used. In some cases, the two predetermined time periods may be set to start at a same time and thus have a different duration so as to expire at different times. Alternatively, the two predetermined time periods may be set so that the second predetermined time period starts upon expiry of the first predetermined time period and may or may not have a same duration as the first predetermined time period. More generally, the control information may specify a plurality of respective time periods comprising at least the above mentioned first and second predetermined time periods. Upon expiry of each time period an increment to the difficulty to increase the difficulty for the video game can be implemented to thereby allow a stepped increase (e.g. ramp up) of the difficulty. In some cases, the control information may be used to increase the difficulty for the video game back to the previous difficulty used prior to the inactivity period. In some example, the control information may also specify a control input for a user which can be provided by the user to stop further increases in the difficulty from the control information (e.g. stop ramp up at a point during the ramp up). Therefore, the control information may be used to allow a ramp up of the difficulty during the next game session with an option for a user to provide the control input for stopping further increases in the difficulty when desired by the user.

Hence more generally, in some embodiments of the disclosure the control information comprises time information indicative of a plurality of times during the next session at which the difficulty is to be automatically increased. Optionally the control information may comprise the control input as discussed above.

Optionally, the control information may comprise reference performance information. The reference performance information may be used during the next session for the video game for comparison with one or more performance metrics for the user's gameplay during the next session so as to allow an automatic increase in difficulty depending on one or more of the performance metrics. Hence, automatic increase of difficulty may be implemented during the next session responsive to monitoring of at least one performance metric for the user.

In some cases, the reference performance information may be used to allow a ramp-up of the difficulty during the next session with a different rate of ramp-up for differing levels of performance during the next session. For example, first reference performance information may specify a first reference level which when satisfied by a monitored performance metric causes a first increase in difficulty and second reference performance information may specify a second reference level which when satisfied by a monitored performance metric causes a second increase in difficulty which is greater than the first increase.

In some embodiments of the disclosure, at least one of the one or more machine learning models has been trained using training data comprising activity information for a number of users, wherein for each user the activity information is indicative of an inactivity period for at least one video game previously played that user and one or more corresponding difficulty settings associated with a subsequent game session of the at least one video game following the inactivity period. As mentioned previously, the training data may take a variety of different forms. The training data may comprise data for a potentially large number of users and for a given user may comprise activity information for that user which is indicative of at least one inactivity period for at a video game previously played that user and also one or more corresponding difficulty settings associated with a subsequent game session for the video game following the inactivity period. In some cases, it can be sufficient for the training data to indicate at least one difficulty setting associated with the subsequent game session so that a difference between that difficulty setting and a prior difficulty setting can indicate that a reduced difficulty has been used. In some cases, the training data may indicate two or more difficulty settings associated with the subsequent game session for thereby indicating that a reduction in difficulty was eventually used by the user for the subsequent game session (i.e. the user started with a given difficulty setting that was used previously and subsequently reduced the difficulty setting during the session). As explained, previously in some cases the training data comprises the inactivity period and an associated label (or other similar identifier) indicating whether a reduction in difficulty was used for a next game session following the inactivity period. The possibilities regarding the training data have been discussed in detail above and the various combinations of training data that may be used will be readily apparent to a person skilled in the art.

In some embodiments of the disclosure, the activity information for the number of users relates to one or more from the list consisting of: a plurality of video games each of a same video game genre; a plurality of video games each of a same video game series; and a same respective video game. Training data comprising activity information for a number of users with respect to a same video game may potentially be used for training a machine learning model for a specific video game. Similarly, training data comprising activity information for a number of users with respect to a plurality of video games of a same video game series may potentially be used for training a machine learning model for a given video game series. Similarly, training data comprising activity information for a number of users with respect to a plurality of video games of a same video game genre may potentially be used for training a machine learning model for a given video game genre. In some cases, issues associated with sparsity of training data for a respective video game may be addressed by using training data relating to a same video game series and/or a same video game genre so as to obtain a suitably trained machine learning model. For example, for a video game with relatively low popularity there may be a sparsity of training data available and the techniques of the present disclosure can allow prediction for such a video game using one or more of a machine learning model trained for a same video game series and/or a machine learning model trained for a same video game genre.

Hence, more generally in some embodiments of the disclosure, the prediction circuitry comprises 220 one or more trained machine learning models, in which the one or more trained machine learning models comprise one or more from the list consisting of: a first trained machine learning model having been trained using training data for a same respective video game; a second trained machine learning model having been trained using training data for a plurality of video games associated with a same respective video game series; and a third trained machine learning model having been trained using training data for a plurality of video games associated with a same video game genre.

FIG. 3 is a schematic flowchart illustrating a computer-implemented method. The method comprising: receiving (at a step 310) user information indicative of an inactivity period for one or more video games previously played by a user; predicting (at a step 320), using one or more trained machine learning models, a mitigation action associated with a respective video game of the one or more video games previously played by the user in dependence on at least an inactivity period for the respective video game; generating (at a step 330) video game mitigation information for the mitigation action associated with the respective video game; and outputting (at a step 340) the video game mitigation information.

It will be appreciated that example embodiments can be implemented by computer software operating on a general purpose computing system such as a games machine. The apparatus discussed with respect to FIG. 2 is for example operable to implement the method of FIG. 3. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims, the disclosure may be practised otherwise than as specifically described herein.

Example(s) of the present technology are defined by the following numbered clauses:

1. An apparatus comprising: receiving circuitry to receive user information indicative of an inactivity period for one or more video games previously played by a user; prediction circuitry to predict a mitigation action associated with a respective video game of the one or more video games previously played by the user in dependence on at least an inactivity period for the respective video game and generate video game mitigation information for the mitigation action associated with the respective video game, the prediction circuitry comprising one or more trained machine learning models to predict the mitigation action in dependence on at least the inactivity period for the respective video game; and output circuitry to output the video game mitigation information.
2. The apparatus according to clause 1, wherein the mitigation action comprises a reduction in difficulty associated with the respective video game.
3. The apparatus according to clause 2, wherein the prediction circuitry is configured to generate the video game mitigation information to comprise video game difficulty setting information, the video game difficulty setting information comprising one or more parameters specifying at least one of a relative reduction in difficulty associated with the respective video game and a difficulty setting to be used for the respective video game.
4. The apparatus according to clause 3, wherein the output circuitry is configured to output the video game mitigation information for use by a video game processing device for execution of a next session of the respective video game according to a difficulty that is dependent on the video game difficulty setting information.
5. The apparatus according to any one of clauses 2 to 4, wherein the prediction circuitry is configured to associate control information with the video game mitigation information for modifying the difficulty during a next session of the respective video game to increase the difficulty in response to one or more of a predetermined input by the user and an elapse of a predetermined period of time during the next session.
6. The apparatus according to clause 5, wherein the control information comprises time information indicative of a plurality of times during the next session at which the difficulty is to be automatically increased.
7. The apparatus according to any preceding clause, wherein the prediction circuitry is configured to generate the video game mitigation information to comprise one or more from the list consisting of: a notification indicative of a controller mapping associated with the respective video game; a tutorial associated with the respective video game; and an auto-complete function associated with the respective video game.
8. The apparatus according to any preceding clause, wherein the user information is indicative of a previous difficulty associated with a previous game session played by the user for the respective video game, and the prediction circuitry is configured to predict the mitigation action associated with the respective video game in dependence on the inactivity period for the respective video game and the previous difficulty associated with the previous game session played by the user for the respective video game.
9. The apparatus according to any preceding clause, wherein the prediction circuitry is configured to predict the mitigation action associated with the respective video game in dependence on whether one or more of the video games previously played by the user have been played during the inactivity period for the respective video game.
10. The apparatus according to any preceding clause, wherein the prediction circuitry is configured to predict the mitigation action associated with the respective video game in dependence on one or more from the list consisting of: a duration of one or more previous game sessions for one or more of the video games during the inactivity period for the respective video game; a genre of one or more of the video games previously played by the user during the inactivity period for the respective video game; and a total duration of one or more previous game sessions for the respective video game within a predetermined period of time.
11. The apparatus according to any preceding clause, wherein at least one of the one or more machine learning models has been trained using training data comprising activity information for a number of users, wherein for each user the activity information is indicative of an inactivity period for at least one video game previously played that user and one or more corresponding difficulty settings associated with a subsequent game session of the at least one video game following the inactivity period.
12. The apparatus according to clause 11, wherein the activity information for each of the users relates to one or more from the list consisting of: a plurality of video games each of a same video game genre; a plurality of video games each of a same video game series; and a same respective video game.
13. The apparatus according to any preceding clause, wherein the one or more trained machine learning models comprise one or more from the list consisting of: a first trained machine learning model having been trained using training data for a same respective video game; a second trained machine learning model having been trained using training data for a plurality of video games associated with a same respective video game series; and a third trained machine learning model having been trained using training data for a plurality of video games associated with a same video game genre.
14. A computer-implemented method comprising: receiving user information indicative of an inactivity period for one or more video games previously played by a user; predicting, using one or more trained machine learning models, a mitigation action associated with a respective video game of the one or more video games previously played by the user in dependence on at least an inactivity period for the respective video game; generating video game mitigation information for the mitigation action associated with the respective video game; and outputting the video game mitigation information.
15. Computer software which when executed by a computer causes the computer to perform the method according to clause 14.

1. An apparatus comprising:
receiving circuitry to receive user information indicative of an inactivity period for one or more video games previously played by a user;
prediction circuitry to predict a mitigation action associated with a respective video game of the one or more video games previously played by the user in dependence on at least an inactivity period for the respective video game and generate video game mitigation information for the mitigation action associated with the respective video game, the prediction circuitry comprising one or more trained machine learning models to predict the mitigation action in dependence on at least the inactivity period for the respective video game; and
output circuitry to output the video game mitigation information.

2. The apparatus according to claim 1, wherein the mitigation action comprises a reduction in difficulty associated with the respective video game.

3. The apparatus according to claim 2, wherein the prediction circuitry is configured to generate the video game mitigation information to comprise video game difficulty setting information, the video game difficulty setting information comprising one or more parameters specifying at least one of a relative reduction in difficulty associated with the respective video game and a difficulty setting to be used for the respective video game.

4. The apparatus according to claim 3, wherein the output circuitry is configured to output the video game mitigation information for use by a video game processing device for execution of a next session of the respective video game according to a difficulty that is dependent on the video game difficulty setting information.

5. The apparatus according to claim 2, wherein the prediction circuitry is configured to associate control information with the video game mitigation information for modifying the difficulty during a next session of the respective video game to increase the difficulty in response to one or more of a predetermined input by the user and an elapse of a predetermined period of time during the next session.

6. The apparatus according to claim 5, wherein the control information comprises time information indicative of a plurality of times during the next session at which the difficulty is to be automatically increased.

7. The apparatus according to claim 1, wherein the prediction circuitry is configured to generate the video game mitigation information to comprise one or more from the list consisting of:
a notification indicative of a controller mapping associated with the respective video game;
a tutorial associated with the respective video game; and
an auto-complete function associated with the respective video game.

8. The apparatus according to claim 1, wherein the user information is indicative of a previous difficulty associated with a previous game session played by the user for the respective video game, and the prediction circuitry is configured to predict the mitigation action associated with the respective video game in dependence on the inactivity period for the respective video game and the previous difficulty associated with the previous game session played by the user for the respective video game.

9. The apparatus according to claim 1, wherein the prediction circuitry is configured to predict the mitigation action associated with the respective video game in dependence on whether one or more of the video games previously played by the user have been played during the inactivity period for the respective video game.

10. The apparatus according to claim 1, wherein the prediction circuitry is configured to predict the mitigation action associated with the respective video game in dependence on one or more from the list consisting of:
a duration of one or more previous game sessions for one or more of the video games during the inactivity period for the respective video game;
a genre of one or more of the video games previously played by the user during the inactivity period for the respective video game; and
a total duration of one or more previous game sessions for the respective video game within a predetermined period of time.

11. The apparatus according to claim 1, wherein at least one of the one or more machine learning models has been trained using training data comprising activity information for a number of users, wherein for each user the activity information is indicative of an inactivity period for at least one video game previously played that user and one or more corresponding difficulty settings associated with a subsequent game session of the at least one video game following the inactivity period.

12. The apparatus according to claim 11, wherein the activity information for each of the users relates to one or more from the list consisting of:
a plurality of video games each of a same video game genre;
a plurality of video games each of a same video game series; and
a same respective video game.

13. The apparatus according to claim 1, wherein the one or more trained machine learning models comprise one or more from the list consisting of:
a first trained machine learning model having been trained using training data for a same respective video game;
a second trained machine learning model having been trained using training data for a plurality of video games associated with a same respective video game series; and
a third trained machine learning model having been trained using training data for a plurality of video games associated with a same video game genre.

14. A computer-implemented method comprising:
receiving user information indicative of an inactivity period for one or more video games previously played by a user;
predicting, using one or more trained machine learning models, a mitigation action associated with a respective video game of the one or more video games previously played by the user in dependence on at least an inactivity period for the respective video game;
generating video game mitigation information for the mitigation action associated with the respective video game; and
outputting the video game mitigation information.

15. A non-transitory computer-readable storage medium storing computer software which when executed by a computer causes the computer to perform a method comprising:
receiving user information indicative of an inactivity period for one or more video games previously played by a user;
predicting, using one or more trained machine learning models, a mitigation action associated with a respective video game of the one or more video games previously played by the user in dependence on at least an inactivity period for the respective video game;
generating video game mitigation information for the mitigation action associated with the respective video game; and
outputting the video game mitigation information.
